(19) United States
(12) Patent Application Publication
(10) Pub. No.: US 2026/0264201 A1
(43) Pub. Date: Sep. 10, 2026

(54) EFFECTIVE KEYCAP RELEASING DESIGN

(71) Applicant: Logitech Europe S.A., Lausanne (CH)

(72) Inventors: Yu-Chun Sun, Hsinchu City (TW); Jhan-Li Wu, Hsinchu City (TW); Frédéric Dot, Lausanne (CH); I Yin Wu, New Taipei City (TW); Wai Bun Choi, Hsinchu City (TW); Szu-Ting Lan, Tainan (TW); Kuanchieh Liang, Hsinchu City (TW); Tetsuya Arimoto, Hsinchu (TW); Chih Mao Lai, Hsinchu City (TW); Peter Mah, Hsinchu City (TW)

(21) Appl. No.: 19/074,942

(22) Filed: Mar. 10, 2025

(51) Int. Cl. B25B 27/00; H01H 13/88

(52) U.S. Cl. CPC B25B 27/00; H01H 13/88

(57) ABSTRACT

A keycap puller is disclosed in the present disclosure. Some embodiments of the keycap puller may include a handle and a puller body coupled with the handle. The puller body may include a first wall and a second wall opposite with each other and extending in parallel to each other and a sliding ramp transversely coupled between the first wall and the second wall. The sliding ramp may include a slot extending from a first end of the sliding ramp toward a second end thereof partially over a length of the sliding ramp. A first sliding rail is formed between the slot and the first wall, and a second sliding rail is formed between the slot and the second wall. Another embodiment of the keycap puller may include a handle and multiple puller bodies arranged side by side, adjacent of which are separated by a section wall.

### BACKGROUND OF THE INVENTION

The present disclosure generally relates to computer peripheral devices. In particular, the present disclosure relates a tool for removing a keycap from a keyboard.

Keyboard is one of the most frequently used computer peripherals. Common keyboards on the market are generally divided into two categories: membrane keyboards and mechanical keyboards. Mechanical keyboards use mechanical shafts, and the keys have a longer key travel, which can give users a superior feel. Most of mechanical keyboards are designed with replaceable keycaps mounted on the key shaft. The user may remove the keycap by a keycap puller. With the trend of keyboard customization, users may frequently take off keycaps to change their keyboard settings for different switches, such as tactile, linear, clicky, silent, etc. In addition, users may take off the keycap to replace it with different keycaps (PBT, ABS, sublimation with favorite animation, etc.). During use of the mechanical keyboard, dust or debris may fall between keys and in the space between the keycap and the top surface of the keyboard. The user may pull off the keycap with the keycap puller to clean the keyboard.

Conventional keycap puller includes to two metallic wire loops coupled with a handle. When releasing the keycap, the user may lasso the opposite edges of a keycap with the two metallic loops and pull the handle upward. Since the lasso-and-pull action must be repeated on each and every keycap that needs to be released, it takes much time to remove a large number of keycaps. Therefore, there has always been a huge design need in the field of keyboards to provide an effective way to release keycaps.

### BRIEF SUMMARY OF THE INVENTION

A keycap puller is proposed in an aspect of the present disclosure. In some embodiments, the keycap puller may include a handle and a puller body coupled with the handle. The puller body may include a first wall and a second wall opposite with each other and extending in parallel to each other and a sliding ramp transversely coupled between the first wall and the second wall. The sliding ramp may include a slot extending from a first end of the sliding ramp toward a second end thereof partially over a length of the sliding ramp. A first sliding rail is formed between the slot and the first wall, and a second sliding rail is formed between the slot and the second wall.

In some embodiments, the first wall includes a first overhang portion at an upper portion of the first wall adjacent the first end of the sliding ramp; and the second wall includes a second overhang portion at an upper portion of the second wall adjacent the first end of the sliding ramp.

In some embodiments, the first sliding rail further includes a first leading arc portion at the first end of the sliding ramp; and the second sliding rail further includes a second leading arc portion at the first end of the sliding ramp.

In some embodiments, the sliding ramp includes a guiding arc portion at the second end thereof, and wherein the guiding arc portion includes a radius of 1-5 mm.

In some embodiments, a gradient of the sliding ramp ranges in 5-15 degrees.

In some embodiments, the length of the sliding ramp ranges in 60-100 mm.

In some embodiments, the handle is pivotably coupled at a first end thereof with the puller body.

In some embodiments, the keycap puller further includes a cover pivotably coupled with a second end of the handle, wherein the second end of the handle is opposite the first end of the handle.

In some embodiments, the handle is slidably coupled with the puller body.

In some embodiments, the handle is detachably coupled with the puller body.

In some embodiments, a minimum distance between the sliding ramp and a bottom of the handle is greater than 18 mm.

In another aspect of the present disclosure, a keycap puller including multiple puller bodies is proposed. In some embodiments, the keycap puller may include a handle comprising a first arm and a second arm, a first puller body coupled with the handle and a second puller body coupled with the handle. The first puller body may include a first wall and a second wall opposite to each other and extending in parallel to each other; and a first sliding ramp transversely coupled between the first wall and the second wall, wherein the first sliding ramp includes a first slot extending from a first end of the first sliding ramp toward a second end thereof partially over a length of the first sliding ramp, wherein a first sliding rail is formed between the first slot and the first wall, and a second sliding rail is formed between the first slot and the second wall. The second puller body may include a third wall and a fourth wall opposite with each other and extending in parallel to each other; and a second sliding ramp transversely coupled between the third wall and the fourth wall, wherein the second sliding ramp includes a second slot extending from a third end of the second sliding ramp toward a fourth end thereof partially over a length of the second sliding ramp, wherein a third sliding rail is formed between the second slot and the third wall, and a fourth sliding rail is formed between the second slot and the fourth wall. The first arm of the handle is coupled with the first wall of the first puller body, the second arm of the handle is coupled with the fourth wall of the second puller body. A first section wall is coupled between the second wall of the first puller body and the third wall of the second puller body.

In some embodiments, the first wall includes a first overhang portion at an upper portion of the first wall adjacent the first end of the first sliding ramp; the second wall includes a second overhang portion at an upper portion of the second wall adjacent the first end of the first sliding ramp; the third wall includes a third overhang portion at an upper portion of the third wall adjacent the third end of the second sliding ramp; the fourth wall includes a fourth overhang portion at an upper portion of the fourth wall adjacent the third end of the second sliding ramp.

In some embodiments, the first sliding rail further includes a first leading arc portion at the first end of the first sliding ramp; the second sliding rail further includes a second leading arc portion at the first end of the first sliding ramp; the third sliding rail further includes a third leading arc portion at the third end of the second sliding ramp; and the fourth sliding rail further includes a fourth leading arc portion at the third end of the second sliding ramp.

In some embodiments, the first sliding ramp includes a first guiding arc portion at the second end thereof, and wherein the first guiding arc portion includes a radius of 1-5 mm; and the second sliding ramp includes a second guiding arc portion at the fourth end thereof, and wherein the second guiding arc portion includes a radius of 1-5 mm.

In some embodiments, a gradient of the first sliding ramp range in 5-15 degrees, and a gradient of the second sliding ramp range in 5-15 degrees.

In some embodiments, the length of the sliding ramp ranges in 60-100 mm.

Numerous benefits have been provided by the inventive concept of the present disclosure. For example, some embodiments of the present disclosure provide a keycap puller, which can efficiently release keycaps from a keyboard. Continued operation of the keycap puller may release a row of keycaps from the keyboard, and a user of the keyboard do not need to put much force during the process. To operate on a typical floating high-profile mechanical keyboard available on the market, it could take about 36 seconds (6 seconds per row) to release all keycaps. It can save about 83% of the time compared with doing the same thing with a conventional keycap puller made of metallic wires. These and many other benefits may be apparent to those of ordinary skill in the art when reading the description below in light of the appended claims.

### BRIEF DESCRIPTION OF THE DRAWINGS

FIGS. 1A and 1B show a schematic perspective view of a keycap puller 100 according to some embodiments of the present disclosure.

FIG. 2 shows a schematic perspective partial view of a keyboard 400 according to some embodiments of the present disclosure.

FIG. 3 shows a schematic perspective view of the puller body 10 according to some embodiments of the present disclosure.

FIGS. 4A-4D show the operation state of the puller body 10 on a keyboard 400 according to some embodiments of the present disclosure, in which the puller body 10 and the keyboard 400 are shown in a longitudinal section view.

FIG. 5 shows the second stage of the operation of the puller body 10 in a front view according to some embodiments of the present disclosure.

FIG. 6 shows the fourth stage of the operation of the puller body 10 in a front view according to some embodiments of the present disclosure.

FIG. 7 shows a partial perspective view of the keycap puller 100 and the keyboard 400 according to some embodiments of the present disclosure.

FIG. 8 shows a schematic right view of the keycap puller 100 and a part of the keyboard 400 according to some embodiments of the present disclosure.

FIGS. 9A and 9B show a schematic perspective view of a keycap puller 200 according to some embodiments of the present disclosure.

FIG. 10 shows a schematic perspective view of the puller body 40 according to some embodiments of the present disclosure.

FIGS. 11 and 12 show a schematic perspective view of the handle 50 according to some embodiments of the present disclosure.

FIGS. 13A and 13B show a schematic perspective view of a keycap puller 300 according to some embodiments of the present disclosure.

FIG. 14 shows a schematic perspective view of another keycap puller 800 according to some embodiments of the present disclosure.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

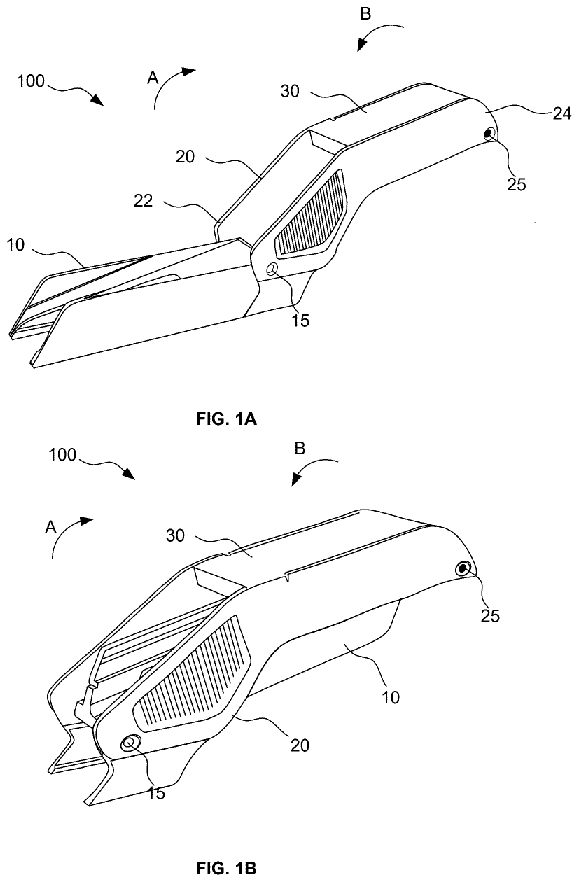

FIGS. 1A and 1B show a schematic perspective view of a keycap puller 100 according to some embodiments of the present disclosure. As illustrated, the keycap puller 100 may include a puller body 10, a handle 20, and a cover 30. In some embodiments, the handle 20 is pivotably coupled at a first end 22 thereof with the puller body 10, and is pivotably coupled at a second end 24 thereof with the cover 30. It should be noted that FIG. 1A shows the keycap puller 100 at the expanded state for operation. After use, the keycap puller 100 could be folded into a stored state, as shown in FIG. 1B. In doing so, a user may rotate the cover 30 in the clockwise direction indicated by arrow A around a pivot axis 25 to open the handle 20. Then the user may rotate the puller body 10 in the clockwise directions indicated by arrow A around a pivot axis 15 to receive the puller body 10 in the interior space of the handle 20. Next, the user may rotate the cover 30 in the counterclockwise direction indicated by arrow B around the pivot axis 25 to close the interior space of the handle 20. The foldable configuration of the keycap puller 100 could effectively reduce the profile of the keycap puller 100 as it is folded into the stored state. It reduces the profile of the keycap puller 100 and facilitates the portability of the keycap puller 100. It should be noted that in some other embodiments, the keycap puller 100 may omit the cover 30. It should also be noted that the handle 20 is not required in some embodiments. The puller body 10 itself may achieve the release of the keycap of a keyboard. However, the handle 20 in some embodiments may help reduce the force a user must act on the puller body 10 to release keycaps from the keyboard.

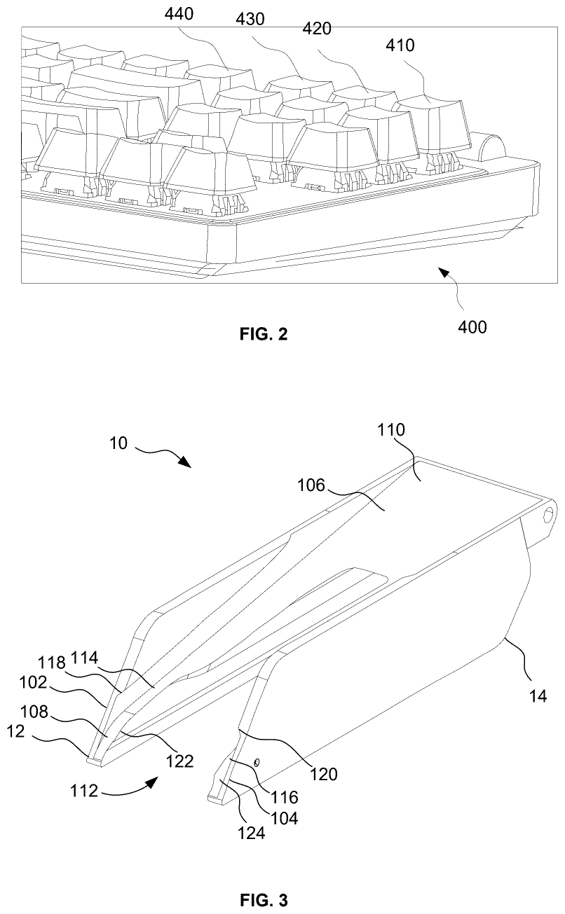

Now the structural details of the keycap puller 200 will be described with reference to FIGS. 2-5.

FIG. 2 shows a schematic perspective partial view of a keyboard 400 according to some embodiments of the present disclosure. As illustrated, the keyboard 400 is a floating high-profile mechanical (optical) keyboard, which facilitates the implementation of the inventive concept of the present disclosure. A floating high-profile keyboard is a mechanical keyboard design where the key switches and keycaps are elevated above the keyboard's case, giving the appearance that the keys are “floating.” This design often showcases the switches and enhances the aesthetic appeal by highlighting the mechanical components. As shown in FIG. 3, the keyboard 400 may include multiple keys, such as a first key 410, a second key 420, a third key 430, and a fourth key 440, which are arranged in the row on the keyboard 400. The below description will describe the operation of the keycap puller 100 (shown in FIGS. 1A and 1B) with reference to the keyboard 400. It should be noted that the embodiments of the keycap puller 100 may also apply to other types of mechanical keyboards.

FIG. 3 shows a schematic perspective view of the puller body 10 according to some embodiments of the present disclosure. In some embodiments, the puller body 10 may include a first wall 102 and a second wall 104 opposite and parallel to the first wall 102. In some embodiments, the first wall 102 and the second wall 104 extend from a first end 12 to the second end 14 of the puller body 10. A sliding ramp 106 is transversely coupled between the first wall 102 and the second wall 104. In some embodiments, the sliding ramp 106 is formed as a slope member extending between the first wall 102 and the second wall 104. For example, as illustrated in FIG. 3, a first end 108 of the sliding ramp 106 is coupled to the lower portion of the first wall 102 and the lower portion of the second wall 104 at the first end 12 of puller body 10, and a second end 110 of the sliding ramp 106 is coupled to the upper portion of the first wall 102 and the upper portion of the second wall 104 at the second end 14 of the puller body 10. In some embodiments, a slot 112 is partially formed in the sliding ramp 106, extending from the first end 108 of the sliding ramp 106 toward the second end 110 of the ramp 106. During the operation of the keycap puller 100, the slot 112 may provide accommodating space for the key shaft to prevent interference between the sliding ramp 106 and the key shaft, which will be described in detail below.

As illustrated in FIG. 3, a first sliding rail 114 is formed between the first wall 102 and the slot 112, and a second sliding rail 116 is formed between the second wall 104 and the slot 112. During the operation of the keycap puller 100, the lower edge of a keycap may contact the first sliding rail 114 and the second sliding rail 116, and slide over the sliding ramp 106, which will be described in detail below. It should be noted that the width between the inner surface of the first wall 102 and the inner surface of the second wall 104 should be configured to be greater than the width of the keycap in order for the keycap puller 100 to operate. In some embodiments, the first wall 102 may include a first overhang portion 118 at the upper portion of the first wall 102 adjacent the first end 12 of the puller body 10, and a second overhang portion 120 at the upper portion of the second wall 104 adjacent the first end 12 of the puller body 10. In some embodiments, the width between the inner surface of the first overhang portion 118 and the inner surface of the second overhang portion 120 is configured to be less than the width between the inner surface of the first wall 102 and the inner surface of the second wall 104, and is configured to be greater than the width of the keycap. Usually, the keycap is designed with tapered side walls with a reduced width at the upper portion of the keycap over the lower portion thereof. During the operation of the keycap puller 100, the first overhang portion 118 and the second overhang portion 120 may be closer to the upper portion of the side walls of the keycap. Thus, the reduced width between the inner surface of the first overhang portion 118 and the inner surface of the second overhang portion 120 may facilitate the stabilize the keycap while the keycap is sliding over the sliding ramp 106.

As illustrated in FIG. 3, in some embodiments, the first sliding rail 114 may include a first leading arc portion 122 at the first end 108 of the sliding ramp 106, and the second sliding rail 116 may include a second leading arc portion 124 at the first end 108 of the sliding ramp 106. In some embodiments, the first leading arc portion 122 and the second leading arc portion 124 may facilitate the first end 108 of the sliding ramp 106 to enter the gap between the keycap and the top surface of the keyboard.

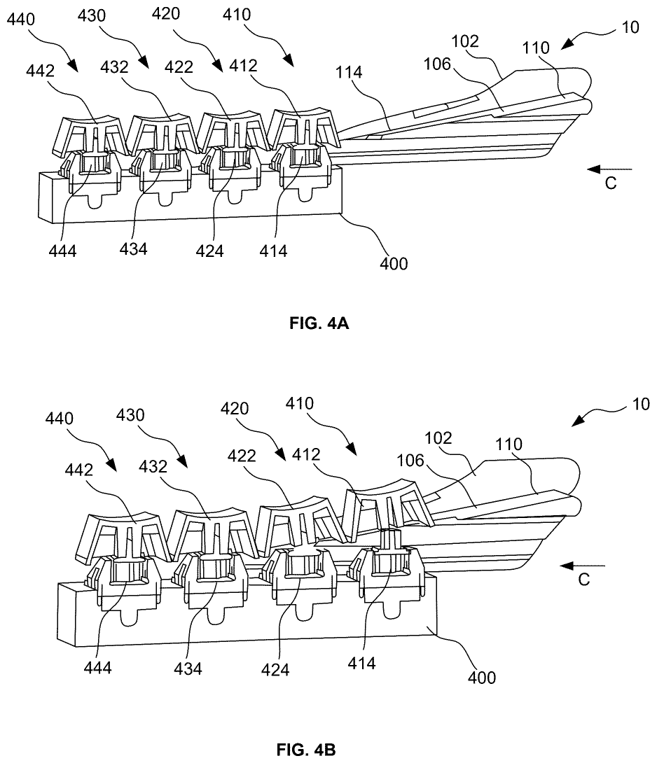

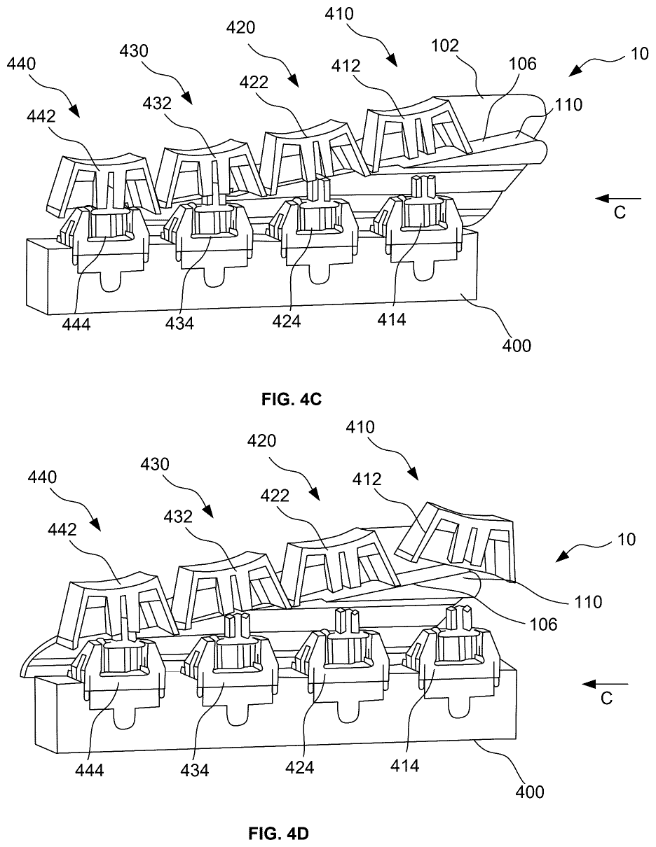

FIGS. 4A-4D show the operation state of the puller body 10 on a keyboard 400 according to some embodiments of the present disclosure, in which the puller body 10 and the keyboard 400 are shown in a longitudinal section view. As illustrated, the keyboard 400 may include multiple keys, for example, a first key 410, a second key 420, a third key 430, and a fourth key 440. For the purpose of illustrating the operation of the puller body 10, the first key 410, the second key 420, the third key 430, and the fourth key 440 are arranged in a row on the keyboard 400. As shown in FIG. 4A, the first key 410 includes a first keycap 412 mounted on a first key shaft 414, the second key 420 includes a second keycap 422 mounted on a second key shaft 424, the third key 430 includes a third keycap 432 mounted on a third key shaft 434, and the fourth key 440 includes a fourth keycap 442 mounted on a fourth key shaft 444.

FIG. 4A shows the first stage of the operation of the puller body 10 according to some embodiments of the present disclosure. As illustrated, the user first pushes the puller body 10 from the right edge of the keyboard 400 toward the left edge of the keyboard 400 in the direction indicated by arrow C, with the first end 108 (shown in FIG. 3) of the sliding ramp 106 enter the gap between the bottom surface of the first keycap 412 and the top surface of the keyboard 400. It should be noted that only half of puller body 10 is shown in FIGS. 4A-4D. In some embodiments, the puller body 10 is symmetrical about its longitudinal axis. Thus, the below descriptions regarding the first wall 102 and the first sliding rail 114 equally apply to the second wall 104 and the second sliding rail 116.

As the user continues to push the puller body 10 toward the left side of the keyboard 400, the first keycap 412 may slide over the sliding ramp 106 along the first sliding rail 114 and the second sliding rail 116 (shown in FIG. 3) toward the second end 110 of the sliding ramp 106. In the processing sliding over the sliding ramp 106, the first keycap 412 begins to move upward relative to the first key shaft 414.

FIG. 4B shows the second stage of the operation of the puller body 10 according to some embodiments of the present disclosure. As the user continues to push the puller body 10 toward the left side subsequent to the first stage, the first keycap 412 gets off the first key shaft 414, and the second keycap 422 begins to move upward relative to the second key shaft 424. At the meanwhile, the first end 108 (shown in FIG. 3) of the sliding ramp 106 enters the gap between the bottom surface of the third keycap 432 and the top surface of the keyboard 400.

FIG. 4C shows the third stage of the operation of the puller body 10 according to some embodiments of the present disclosure. As the user continues to push the puller body 10 toward the left side subsequent to the second stage, the first keycap 412 continues to move over the sliding ramp 106 toward the second end 110 thereof, the second keycap 422 gets off the second key shaft 424, and the third keycap 432 begins to move upward relative to the third key shaft 434. At the meanwhile, the first end 108 (shown in FIG. 3) of the sliding ramp 106 enters the gap between the bottom surface of the fourth keycap 442 and the top surface of the keyboard 400.

FIG. 4D shows the fourth stage of the operation of the puller body 10 according to some embodiments of the present disclosure. As the user continues to push the puller body 10 toward the left side subsequent to the third stage, the first keycap 412 fall off the second end 110 of the sliding ramp 106, the second keycap 422 continues to move over the sliding ramp 106 toward the second end 110 thereof, the third keycap 432 gets off the third key shaft 434, and the fourth keycap 442 begins to move upward relative to the fourth key shaft 444. If there is an additional key arranged at the left side of the fourth key 440, then the first end 108 (shown in FIG. 3) of the sliding ramp 106 may enter the gap between the bottom surface of the additional keycap and the top surface of the keyboard 400.

The above first to the fourth stage could be repeated until all keycaps of the keys in the row could be released from their respective key shaft one by one.

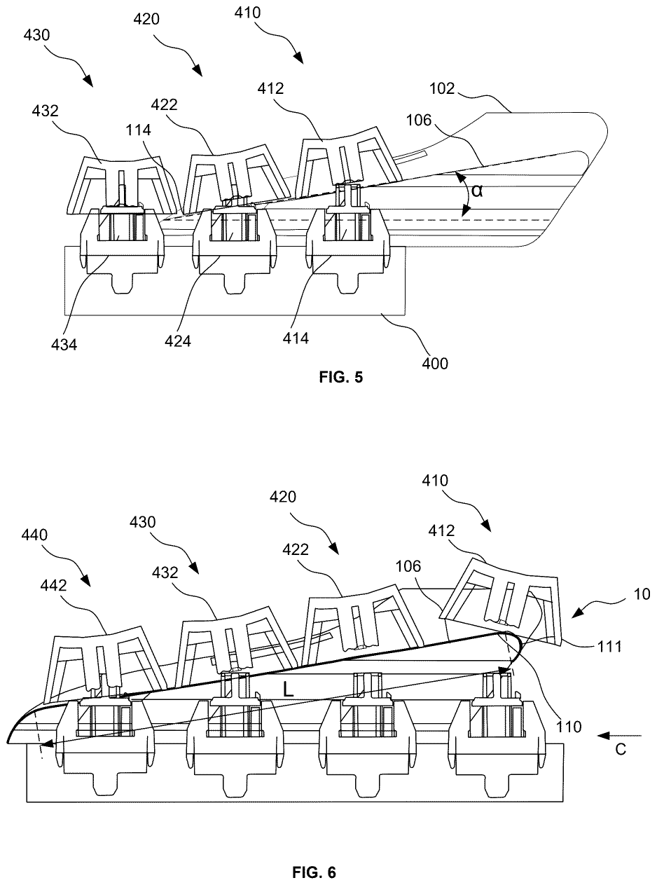

FIG. 5 shows the second stage of the operation of the puller body 10 in a front view according to some embodiments of the present disclosure. The fourth key 440 is omitted from FIG. 5 for clarity of illustration. As illustrated, in some embodiments, the gradient α of the sliding ramp 106 may be configured to release one keycap (for example, the first keycap 412) from its key shaft (for example, the first key shaft 414) while the next keycap (for example, the second keycap 422) remains halfway released on its key shaft (for example, the second key shaft). As used herein, the gradient α represents the included angle between the surface of the sliding ramp 106 and the horizontal direction. The gradient α of the sliding ramp 106 should not be configured to be too gradual. Otherwise, the keycap (for example, the second keycap 422) would have interference with the previous keycap (for example, the first keycap 412) because both the keycap and the previous keycap remain unreleased from their respective key shaft. On the other hand, the gradient α of the sliding ramp 106 should not be configured to be too steep. Otherwise, the user may experience large resistance to releasing a keycap from its key shaft. In some embodiments, the gradient α of the sliding ramp 106 may range in 5-15 degrees. In some other embodiments, the gradient of the sliding ramp 106 may range in 9.3-10 degrees.

FIG. 6 shows the fourth stage of the operation of the puller body 10 in a front view according to some embodiments of the present disclosure. In some embodiments, the length L of the sliding ramp 106, i.e., the planar portion of the sliding ramp 106, is configured to receive at least 4 keycaps. To adapt to the common mechanical keyboard on the market, the length L of the sliding ramp 106 may be configured to be at least 69 mm. In some embodiments, the length L of the sliding ramp 106 may range in 60-100 mm. As shown in FIG. 5, the sliding ramp 106 may include a guiding arc portion 111 at the second end thereof. In some embodiments, the guiding arc portion 111 is configured to allow the keycap to fall off the sliding ramp 106 and land at a location adjacent to its key shaft. In some embodiments, the radius of the arc portion 111 may be configured to be 1-5 mm. In some embodiments, the radius of the guiding arc portion 111 may be 2 mm.

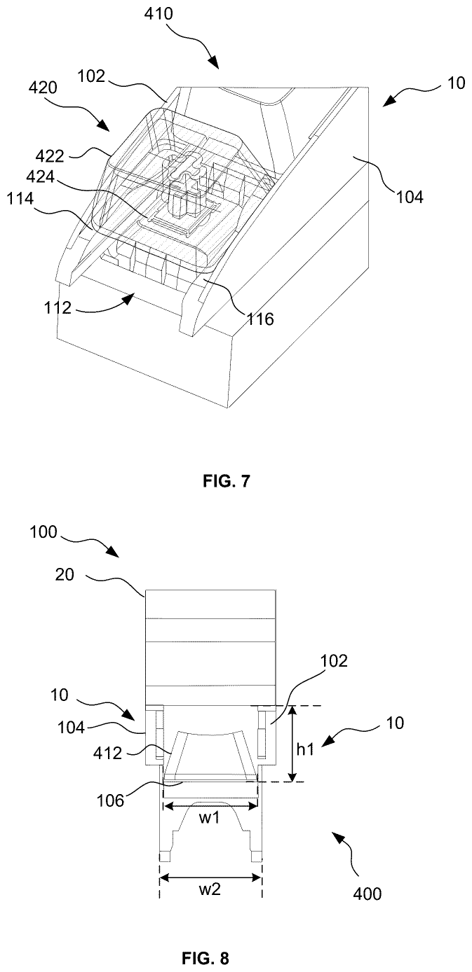

FIG. 7 shows a partial perspective view of the keycap puller 100 and the keyboard 400 according to some embodiments of the present disclosure. The second keycap 422 is shown in the translucent to better show the structural relationship. As illustrated, during the operation of the keycap puller 100, the sliding ramp 106 entered the gap between the bottom surface of the second keycap 422 and the top surface of the keyboard 400. As shown in FIG. 7, the lower edge of the second keycap 422 slides over the first sliding rail 114 and the second sliding rail 116. The slot 112 provides accommodating space for the passage of the second key shaft 424 without interference between the second key shaft 424 and the sliding ramp 106. The first wall 102 and the second wall 104 provide guidance for sliding of the second keycap 422 over the sliding ramp 106.

FIG. 8 shows a schematic right view of the keycap puller 100 and a part of the keyboard 400 according to some embodiments of the present disclosure. For clarity of illustration, only one keycap, such as the first keycap 412 is shown in FIG. 8. In some embodiments, the width w1 of the sliding ramp 106 is configured to be range in 15-30 mm to accommodate different widths of the keycaps of the keyboard 400 available on the market. In one embodiment, the width w1 of the sliding ramp 106 is 18 mm. In some embodiments, the minimum distance h1 between the sliding ramp 106 and the bottom of the handle 20, i.e. the distance between the second end 110 (shown in FIG. 3) of the sliding ramp 106 and the bottom of the handle 20 is configured to be greater than 18 mm to accommodate different height of the keycaps of keyboard 400 available on the market. In some embodiments, the width w2 of the lower portion of the puller body 10, i.e., the portion that is placed between the rows of keys on the keyboard 400, is configured to range from 20-25 mm to accommodate the different key arrangements of the keyboard 400 available on the market. In one embodiment, the width w2 of the lower portion of the puller body 10 is 20 mm. It should be noted that the lower portion of the puller body could be designed not to interfere with adjacent rows of the keys on the keyboard 400 during the operation of the keycap puller 100.

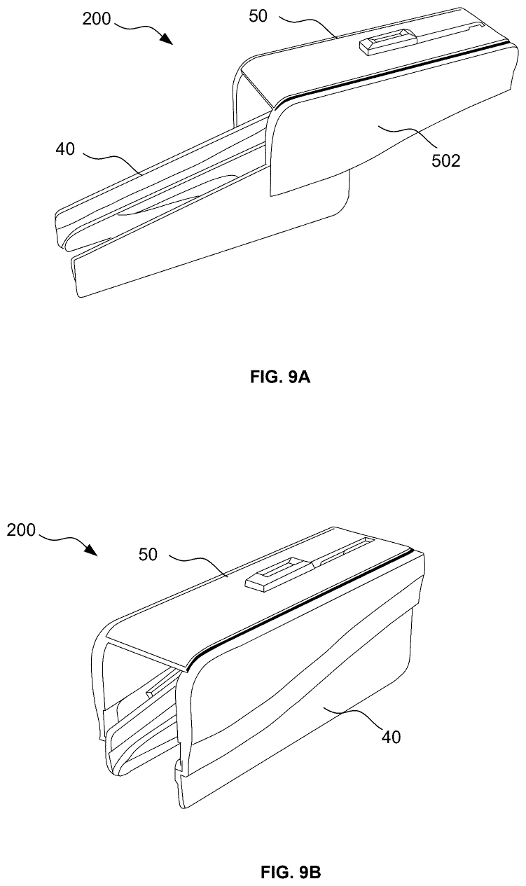

FIGS. 9A and 9B show a schematic perspective view of a keycap puller 200 according to some embodiments of the present disclosure. As illustrated, keycap puller 200 is designed as a slidable configuration instead of a foldable configuration shown in FIGS. 1A and 1B. As illustrated, the keycap puller 200 may include a puller body 40, a handle 50. FIG. 9A shows that the keycap puller 200 is in the extended state for operation. After use, the keycap puller 200 could slide into a stored state, as shown in FIG. 9B, in which the puller body 40 slides into the interior space of the handle 50. It reduces the profile of the keycap puller 200 and facilitates the portability of the keycap puller 100.

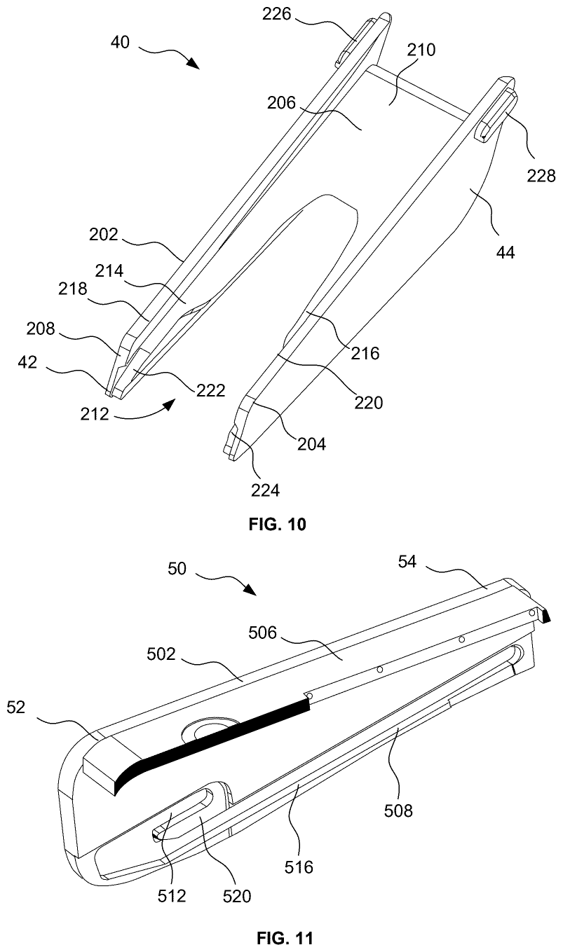

Now the structural details of the keycap puller 200 will be described with reference to FIGS. 10-12.

FIG. 10 shows a schematic perspective view of the puller body 40 according to some embodiments of the present disclosure. The general structure of the puller body 40 is similar to that of the puller body 10 shown in FIG. 3, with the difference that the puller body 40 is configured with sliding members to couple with a corresponding receiving member of the handle 50, which will be described in detail below.

In some embodiments, the puller body 40 may include a first wall 202 and a second wall 204 opposite and parallel to the first wall 202. In some embodiments, the first wall 202 and the second wall 204 extend from a first end 42 to the second end 44 of the puller body 40. A sliding ramp 206 is transversely coupled between the first wall 202 and the second wall 204. In some embodiments, the sliding ramp 206 is formed as a slope member extending between the first wall 202 and the second wall 204. For example, as illustrated in FIG. 10, a first end 208 of the sliding ramp 206 is coupled to the lower portion of the first wall 202 and the lower portion of the second wall 204 at the first end 42 of puller body 40, and a second end 210 of the sliding ramp 206 is coupled to the upper portion of the first wall 202 and the upper portion of the second wall 204 at the second end 44 of the puller body 40. In some embodiments, a slot 212 is partially formed in the sliding ramp 206, extending from the first end 208 of the sliding ramp 206 toward the second end 210 of the ramp 206. During the operation of the keycap puller 200, the slot 212 may provide accommodating space for the key shaft to prevent interference between the sliding ramp 206 and the key shaft, which will be described in detail below.

As illustrated in FIG. 10, a first sliding rail 214 is formed between the first wall 202 and the slot 212, and a second sliding rail 216 is formed between the second wall 204 and the slot 212. During the operation of the keycap puller 200, the lower edge of a keycap may contact the first sliding rail 214 and the second sliding rail 216, and slide over the sliding ramp 206. It should be noted that the width between the inner surface of the first wall 202 and the inner surface of the second wall 204 should be configured to be greater than the width of the keycap in order for the keycap puller 200 to operate. In some embodiments, the first wall 202 may include a first overhang portion 218 at the upper portion of the first wall 202 adjacent to the first end 42 of the puller body 40, and a second overhang portion 220 at the upper portion of the second wall 204 adjacent the first end 42 of the puller body 40. In some embodiments, the width between the inner surface of the first overhang portion 218 and the inner surface of the second overhang portion 220 is configured to be less than the width between the inner surface of the first wall 202 and the inner surface of the second wall 204, and is configured to be greater than the width of the keycap. Usually, the keycap is designed with tapered side walls with a reduced width at the upper portion of the keycap over the lower portion thereof. During the operation of the keycap puller 200, the first overhang portion 218 and the second overhang portion 220 may be closer to the upper portion of the side walls of the keycap. Thus, the reduced width between the inner surface of the first overhang portion 218 and the inner surface of the second overhang portion 220 may facilitate the stabilization of the keycap while the keycap is sliding over the sliding ramp 206.

As illustrated in FIG. 10, in some embodiments, the first sliding rail 214 may include a first arc portion 222 at the first end 208 of the sliding ramp 206, and the second sliding rail 216 may include a second arc portion 224 at the first end 208 of the sliding ramp 206. In some embodiments, the first arc portion 222 and the second arc portion 224 may facilitate the first end 208 of the sliding ramp 206 to enter the gap between the keycap and the top surface of the keyboard.

As shown in FIG. 10, the puller body 40 differs from the puller body shown in FIG. 3 in that the first wall 202 includes a first guiding member 226 coupled to the upper portion of the outer surface of the first wall 202 at the second end 44 of the puller body 40, and the second wall 204 includes a second guiding member 228 opposite the first guiding member 226 and coupled to the upper portion of the outer surface of the second wall 204. In some embodiments, the first guiding member 226 and the second guiding member 228 may receive in a respective receiving track formed the handle 50 to achieve the sliding motion of the puller body 40 in relation to the handle 50, making it possible that the keycap puller 200 to switch between the extended state and the stored state, which will be described below.

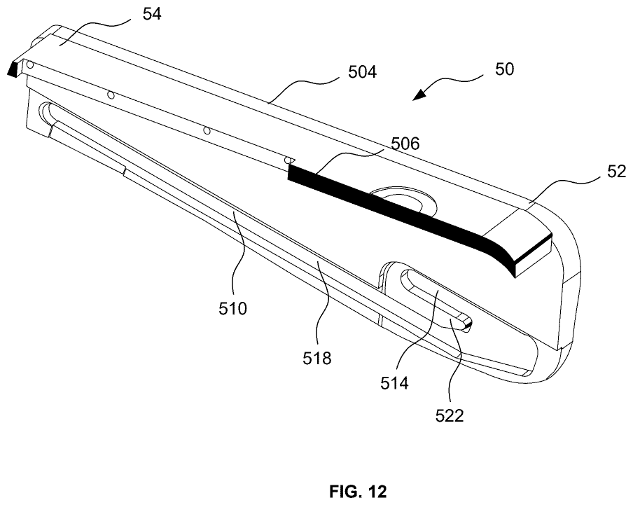

FIGS. 11 and 12 show a schematic perspective view of the handle 50 according to some embodiments of the present disclosure. To better illustrate the interior structure, the handle 50 is shown in a longitudinal section view. As illustrated in FIG. 11, the handle 50 may include a first side wall 502 and a second side wall 504 (shown in FIG. 12) opposite the first side wall 502. As shown in FIG. 10, the first side wall 502 and the second side wall 504 are connected by a top plate 506. In some embodiments, the first side wall 502 may include a first receiving track 508 formed in the interior surface of the first side wall 502 at the lower portion of the first side wall 502. In some embodiments, the first receiving track 508 extends from the first end 52 of the handle 50 to the second end 54 thereof. In some embodiments, the first receiving track 508 is configured to include a first reverse portion 512 at the first end 52 of the handle 50 and separated from the main portion 516 of the first receiving track 508 by a first sectional member 520. Similarly, as shown in FIG. 12, the second side wall 504 may include a second receiving track 510 formed in the interior surface of the second side wall 504 at the lower portion of the second side wall 504. In some embodiments, the second receiving track 510 extends from the first end 52 of the handle 50 to the second end 54 thereof. In some embodiments, the second receiving track 510 is configured to include a second reverse portion 514 at the first end 52 of the handle 50 and separated from the main portion 518 of the second receiving track 510 by a second sectional member 522. It should be noted that the first receiving track 508 and the second receiving track 510 are positioned symmetrically about the longitudinal axis of the handle 50. In some embodiments, when assembled, the first guiding member 226 of the puller body 40 may be received in the first receiving track 508, and the second guiding member 228 of the puller body 40 may be received in the second receiving track 510. A user may push the puller body 40 to make the puller body 40 slide in relation to the handle 50. As the first guiding member 226 reaches the leading end of the first receiving track 508 adjacent the first end 52 of the handle 50, and the second guiding member 228 reaches the leading end of the second receiving track 510 adjacent the first end 52 of the handle 50, the user may push the puller body 40 to move upward to make the first guiding member 226 received in the first reverse portion 512 and the second guiding member 228 received in the second reverse portion 514. Thus, the keycap puller 200 is placed in the extended state. The first reverse portion 512 and the second reverse portion 514 make sure that the resistance of the keyboard when operating the keycap puller 200 could not reversely move the puller body 40 in relation to the handle 50. After use, a reverse movement of the puller body 40 in relation to the handle 50 could place the keycap puller 200 into the stored state.

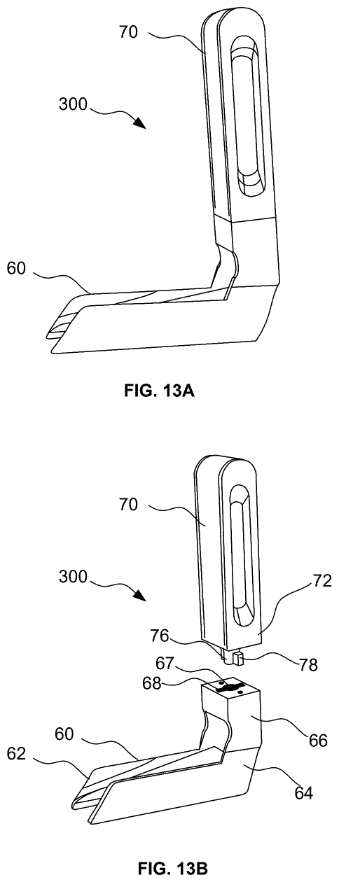

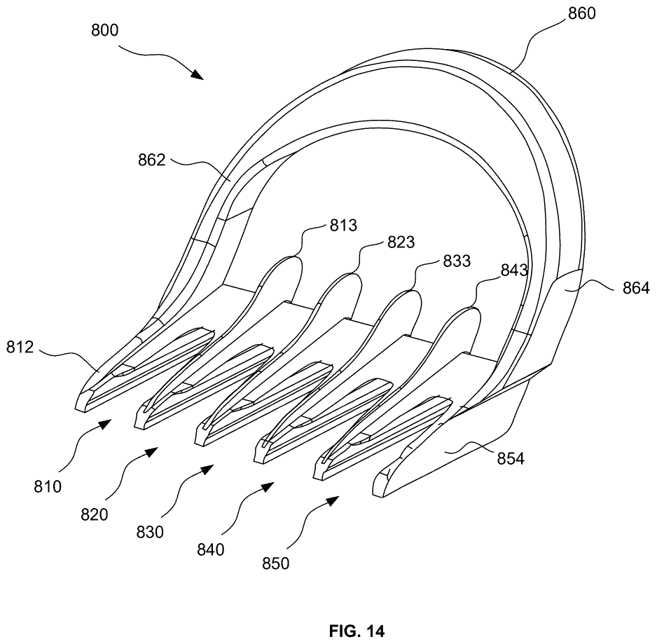

FIGS. 13A and 13B show a schematic perspective view of a keycap puller 300 according to some embodiments of the present disclosure. As illustrated, keycap puller 300 is designed as a detachable configuration instead of a foldable configuration shown in FIGS. 1A and 1B. As illustrated, the keycap puller 300 may include a puller body 60, a handle 70. FIG. 13A shows that the keycap puller 300 is in the assembled state for operation, and FIG. 13B shows the keycap puller 300 in the detached state, in which the puller body 60 may be replaced by another tool.

As shown in FIG. 13B, the puller body 60 is structured similarly to the puller body 10 shown in FIG. 3, except that the puller body 60 may include a connector portion 66 at the second end 64 of the puller body 60. The first end 62 of the puller body 60 is the end that may be operated to release a keycap. The walls and sliding ramp of the puller body 60 are similar to those of the puller body 10 shown in FIG. 3. Thus, relevant description in relation to the first wall 102, the second wall 104, and the sliding ramp 106 of the puller body 10 equally apply to the puller body 60. As illustrated, the connector portion 66 extends upward and includes a socket 67 with two wings 68 opposite each other. In some embodiments, at an end 72, the handle 70 may include an insert 76 with two ears 78 opposite each other. When assembling the puller body 60 with the handle 70, a user may align the insert 76 of the handle 70 with the socket 67 of the puller body 60, with the ears 78 of the insert 76 aligning with the wings 68. Then, the user may push the handle 70 to make the insert 76 received in the socket 67. After that, the user may rotate the handle 70 relative to the puller body 60 in a clockwise direction or a counterclockwise direction by 90 degrees to make the handle 70 coupled with the puller body 60, as shown in FIG. 13A.

FIG. 14 shows a schematic perspective view of another keycap puller 800 according to some embodiments of the present disclosure. As illustrated, the keycap puller 800 may include five puller bodies 810, 820, 830, 840, and 850. A first section wall 813 is positioned between the first puller body 810 and the second puller body 820, a second section wall 823 is positioned between the second puller body 820 and the third puller body 830, a third section wall 833 is positioned between the third puller body 830 and the fourth puller body 840, and a fourth section wall 843 is positioned between the fourth puller body 840 and the fifth puller body 850. In addition, the keycap puller 800 may include a handle 860 with a first arm 862 and a second arm 864. As illustrated, the first arm 862 is coupled with an outer side wall 812 of the first puller body 810, and the second arm 864 is coupled with an outer side wall 854 of the fifth puller body 850. Each of the puller bodies 810 to 850 share a similar structure as the puller body 10 shown in 3 in relation to the walls and sliding ramp of each puller body 810 to 850. Thus the description about the first wall 102, the second wall 104, and sliding ramp 106 with reference to FIG. 3 above equally apply to the walls and sliding ramps of the puller bodies 810-850. Usually, a keyboard, such as the keyboard 400 shown in FIG. 2, has five rows of keys. Thus, the keycap puller 800 may release the five rows of keycaps from respective keys on the keyboard simultaneously. It greatly saves time for releasing keycaps from the keyboard. It should be noted that the keycap puller 800 is not required to include five puller bodies. In some other embodiments, a keycap puller may include two, three, or four puller bodies.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A keycap puller, comprising:
a handle;
a puller body coupled with the handle, wherein the puller body comprises:
a first wall and a second wall opposite with each other and extending in parallel to each other; and
a sliding ramp transversely coupled between the first wall and the second wall,
wherein the sliding ramp comprises a slot extending from a first end of the sliding ramp toward a second end thereof partially over a length of the sliding ramp,
wherein a first sliding rail is formed between the slot and the first wall, and a second sliding rail is formed between the slot and the second wall.

2. The keycap puller of claim 1, wherein
the first wall comprises a first overhang portion at an upper portion of the first wall adjacent the first end of the sliding ramp; and
the second wall comprises a second overhang portion at an upper portion of the second wall adjacent the first end of the sliding ramp.

3. The keycap puller of claim 2, wherein
the first sliding rail further comprises a first leading arc portion at the first end of the sliding ramp; and
the second sliding rail further comprises a second leading arc portion at the first end of the sliding ramp.

4. The keycap puller of claim 1, wherein the sliding ramp comprises a guiding arc portion at the second end thereof, and wherein the guiding arc portion comprises a radius of 1-5 mm.

5. The keycap puller of claim 1, wherein a gradient of the sliding ramp ranges in 5-15 degrees.

6. The keycap puller of claim 1, wherein the length of the sliding ramp ranges in 60-100 mm.

7. The keycap puller of claim 1, wherein the handle is pivotably coupled at a first end thereof with the puller body.

8. The keycap puller of claim 7, further comprises a cover pivotably coupled with a second end of the handle, wherein the second end of the handle is opposite the first end of the handle.

9. The keycap puller of claim 1, wherein the handle is slidably coupled with the puller body.

10. The keycap puller of claim 1, wherein the handle is detachably coupled with the puller body.

11. The keycap puller of claim 1, wherein a width of the sliding ramp ranges in 15-30 mm.

12. The keycap puller of claim 1, wherein a minimum distance between the sliding ramp and a bottom of the handle is greater than 18 mm.

13. A keycap puller, comprising:
a handle comprising a first arm and a second arm;
a first puller body coupled with the handle, wherein the first puller body comprises:
a first wall and a second wall opposite to each other and extending in parallel to each other; and
a first sliding ramp transversely coupled between the first wall and the second wall,
wherein the first sliding ramp comprises a first slot extending from a first end of the first sliding ramp toward a second end thereof partially over a length of the first sliding ramp, and
wherein a first sliding rail is formed between the first slot and the first wall, and a second sliding rail is formed between the first slot and the second wall;
a second puller body coupled with the handle, wherein the second puller body comprises:
a third wall and a fourth wall opposite with each other and extending in parallel to each other; and
a second sliding ramp transversely coupled between the third wall and the fourth wall, wherein the second sliding ramp comprises a second slot extending from a third end of the second sliding ramp toward a fourth end thereof partially over a length of the second sliding ramp,
wherein a third sliding rail is formed between the second slot and the third wall, and a fourth sliding rail is formed between the second slot and the fourth wall,
wherein the first arm of the handle is coupled with the first wall of the first puller body, the second arm of the handle is coupled with the fourth wall of the second puller body, and a first section wall is coupled between the second wall of the first puller body and the third wall of the second puller body.

14. The keycap puller of claim 13, wherein
the first wall comprises a first overhang portion at an upper portion of the first wall adjacent the first end of the first sliding ramp;
the second wall comprises a second overhang portion at an upper portion of the second wall adjacent the first end of the first sliding ramp;
the third wall comprises a third overhang portion at an upper portion of the third wall adjacent the third end of the second sliding ramp; and
the fourth wall comprises a fourth overhang portion at an upper portion of the fourth wall adjacent the third end of the second sliding ramp.

15. The keycap puller of claim 14, wherein
the first sliding rail further comprises a first leading arc portion at the first end of the first sliding ramp;
the second sliding rail further comprises a second leading arc portion at the first end of the first sliding ramp;
the third sliding rail further comprises a third leading arc portion at the third end of the second sliding ramp; and
the fourth sliding rail further comprises a fourth leading arc portion at the third end of the second sliding ramp.

16. The keycap puller of claim 13, wherein the first sliding ramp comprises a first guiding arc portion at the second end thereof, and wherein the first guiding arc portion comprises a radius of 1-5 mm; and
the second sliding ramp comprises a second guiding arc portion at the fourth end thereof, and wherein the second guiding arc portion comprises a radius of 1-5 mm.

17. The keycap puller of claim 13, wherein a gradient of the first sliding ramp range in 5-15 degrees, and a gradient of the second sliding ramp range in 5-15 degrees.

18. The keycap puller of claim 13, wherein the length of the sliding ramp ranges in 60-100 mm.
